(19) United States
(12) Patent Application Publication
(10) Pub. No.: US 2024/0068576 A1
(43) Pub. Date: Feb. 29, 2024

(54) FLUID VALVE SYSTEM

(71) Applicant: Hanon Systems, Daejeon (KR)

(72) Inventor: Emma Michelle Grissom, Howell, MI (US)

(21) Appl. No.: 17/823,252

(22) Filed: Aug. 30, 2022

(51) Int. Cl. F16K 5/10; F16K 5/12; F16K 11/02

(52) U.S. Cl. CPC F16K 5/10; F16K 5/12; F16K 11/025

(57) ABSTRACT

A fluid valve system including a housing defining a plurality of flow paths and a flow control assembly disposed in the housing. The flow control assembly includes a stationary member having a plurality of openings formed therein, and a rotatable member provided with a flow member. When the rotatable member is in a first position, the flow control assembly permits a flow of a first fluid through a first flow path and a flow of a second fluid through a second flow path, and when the rotatable member in a second position, the flow control assembly permits a flow of the first fluid through a third flow path and a flow of the second fluid through a fourth flow path.

### FIELD

The disclosure relates to a fluid valve system, and more particularly to a fluid valve system having a flow control assembly which optimizes performance.

### BACKGROUND

Vehicle heat exchanges, such as radiators, have valves which are used to control the rate that a fluid such as coolant, for example, is allowed to flow through the system. With the increase in government mandated fuel economy regulations, companies are increasingly looking for new technology that will reduce the parasitic losses and improve efficiency of internal combustion engines. Furthermore, the introduction of hybrid and fully electric vehicle powertrains has introduced powertrain and thermal management complexities due to the need to control the temperature of batteries, inverter electronics, electric motors, etc. These trends lead to the need for more intelligently controlled fluid valve systems.

Conventional valve systems include diverter balls, cylinders, and the like to enable the heat exchangers to receive various intake and exhaust flows. As such, a single heat exchanger may function as a charge air cooler (CAC), exhaust gas recirculation (EGR) cooler, and heat recovery device. While these designs may provide adequate performance for proportional flow applications, they do have some drawbacks. For example, such valve systems are cost prohibitive and require complex assemblies.

Accordingly, it would be desirable to produce a fluid valve system wherein a weight, a cost, and complexity thereof is minimized, while optimizing a performance thereof.

### SUMMARY

In concordance and agreement with the presently described subject matter, a fluid valve system wherein a weight, a cost, and complexity thereof is minimized, while optimizing a performance thereof, have surprisingly been discovered.

In one embodiment, a flow control assembly, comprises: a first member having a plurality of openings formed therein; and a second member provided with a flow member, wherein the second member is configured to selectively control a flow of a plurality of fluids through the openings formed in the first member.

In some embodiments, the first member is stationary.

In some embodiments, the second member is rotatable relative to the first member.

In some embodiments, the flow member fluidly connects one of the openings formed in the first control member to another one of the openings formed therein.

In some embodiments, the flow member fluidly connects a fluid inlet with a fluid outlet.

In some embodiments, the first member has a generally circular shape.

In some embodiments, the second member has a generally semi-circular shape.

In some embodiments, the flow member includes a passageway formed therein.

In some embodiments, the flow member is releasably coupled to the second member.

In some embodiments, the flow member includes a plurality of retaining elements configured to cooperate with the second member to secure the flow member thereto.

In some embodiments, the flow control assembly further comprising a sealing element disposed between the second member and the flow member to form a substantially fluid-tight seal therebetween.

In another embodiments, a fluid valve system, comprises: a housing defining a plurality of flow paths; and a flow control assembly disposed in the housing, wherein the flow control assembly is configured to selectively control a flow of at least one fluid through the flow paths of the housing.

In some embodiments, the housing includes a plurality of fluid inlets and a plurality of fluid outlets.

In some embodiments, the flow control assembly is positioned in the housing between a first inlet and a second inlet.

In some embodiments, the flow control assembly includes a flow member having a passageway formed therein, and wherein the passageway is configured to permit the flow of the at least one fluid through at least one of the flow paths.

In some embodiments, the housing defines a first flow path, a second flow path, a third flow path, and a fourth flow path.

In some embodiments, the housing includes a first inlet, a second inlet, a first outlet, and a second outlet, and wherein the first flow path is configured to permit a flow of a first fluid from the first inlet to the second outlet, the second flow path is configured to permit a flow of a second fluid from the second inlet to the first outlet, the third flow path is configured to permit a flow of the first fluid from the first inlet to the first outlet, and the fourth flow path is configured to permit a flow of the second fluid from the second inlet to the first outlet.

In some embodiments, the flow control assembly includes a stationary member and a rotatable member configured to rotate relative to the stationary member.

In some embodiments, the rotatable member in a first position is configured to permit the flow of the first fluid through the first flow path and the flow of the second fluid through the second flow path, and wherein the rotatable member in a second position is configured to permit the flow of the first fluid through the third flow path and the flow of the second fluid through the fourth flow path.

In yet another embodiments, a method of controlling fluid flow, comprises the steps of: providing a housing defining a plurality of fluid flow paths and a flow control assembly disposed in the housing; and actuating the flow control assembly to selectively control a flow of at least one fluid through the fluid flow paths of the housing.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a partially exploded perspective view of a fluid valve system according to an embodiment of the present disclosure, wherein the fluid valve system includes a housing having a flow control assembly disposed therein;

FIG. 2A is a cross-sectional view of the fluid valve system of FIG. 1 taken along section line A-A shown in FIG. 1;

FIG. 2B is a cross-sectional view of the fluid valve system of FIG. 1 taken along section line B-B shown in FIG. 1;

FIG. 2C is a cross-sectional view of the fluid valve system of FIG. 1 taken along section line C-C shown in FIG. 1;

FIG. 2D is a cross-sectional view of the fluid valve system of FIG. 1 taken along section line D-D shown in FIG. 1;

FIG. 3 is a top plan view of a stationary member of the flow control assembly of FIG. 1;

FIG. 4 is a top plan view of a rotatable member of the flow control assembly of FIG. 1;

FIG. 5 is a top plan view of the rotatable member provided with a flow member of the flow control assembly of FIG. 1;

FIG. 6 is a side elevational view of the rotatable member provided with the flow member of FIGS. 1 and 5;

FIG. 7 is a cross-sectional view of the rotatable member provided with the flow member taken along section line E-E shown in FIG. 5;

FIG. 8 is a schematic top plan view of the flow control assembly, wherein the flow member is shown in a first position for a first operating mode of the fluid valve system;

FIG. 9 is a schematic top plan view of the flow control assembly, wherein the flow member is shown in a second position for a second operating mode of the fluid valve system;

FIG. 10 is a partially exploded perspective view of a fluid valve system according to another embodiment of the present disclosure, wherein the fluid valve system includes a housing having another embodiment of a flow control assembly disposed therein;

FIG. 11A is a cross-sectional view of the fluid valve system of FIG. 10 taken along section line F-F shown in FIG. 10;

FIG. 11B is a cross-sectional view of the fluid valve system of FIG. 10 taken along section line G-G shown in FIG. 10;

FIG. 11C is a cross-sectional view of the fluid valve system of FIG. 10 taken along section line H-H shown in FIG. 10;

FIG. 11D is a cross-sectional view of the fluid valve system of FIG. 10 taken along section line I-I shown in FIG. 10;

FIG. 12 is a top plan view of a rotatable member of the flow control assembly of FIG. 10, wherein the flow member is not shown;

FIG. 13 is a top plan view of a rotatable member provided with a flow member for the flow control assembly shown in FIG. 10;

FIG. 14 is a cross-sectional view of the rotatable member provided with the flow member taken along section line J-J shown in FIG. 13;

FIG. 15 is a schematic top plan view of a flow control assembly including the rotatable member of FIGS. 10 and 12-14, wherein the flow member is shown in a first position for a first operating mode of the fluid valve system; and

FIG. 16 is a schematic top plan view of the flow control assembly including the rotatable member of FIGS. 10 and 12-14, wherein the flow member is shown in a second position for a second operating mode of the fluid valve system.

### DETAILED DESCRIPTION OF AN EMBODIMENT OF THE DISCLOSURE

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

All documents, including patents, patent applications, and scientific literature cited in this detailed description are incorporated herein by reference, unless otherwise expressly indicated. Where any conflict or ambiguity may exist between a document incorporated by reference and this detailed description, the present detailed description controls.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, all compositional percentages are by weight of the total composition, unless otherwise specified. Disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

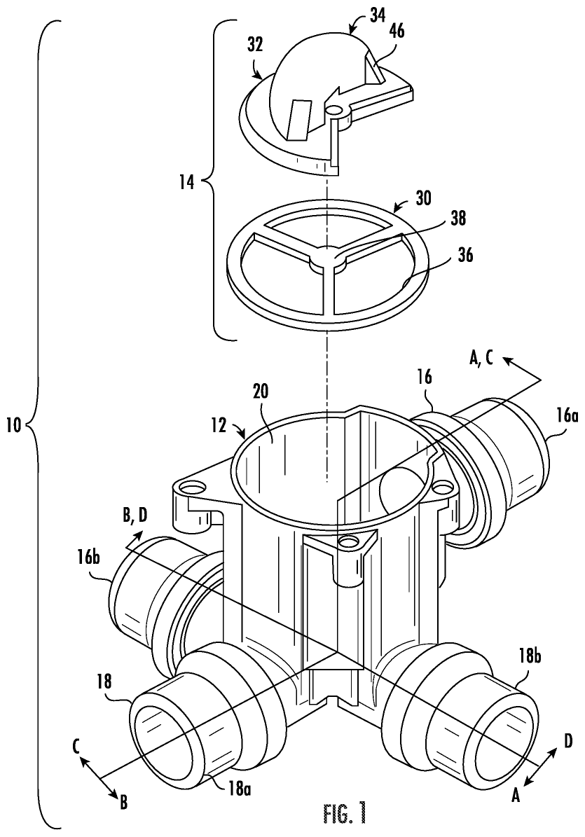

FIG. 1 illustrates a fluid valve system 10 in accordance with an embodiment of the present disclosure. In The fluid valve system 10 may be in fluid communication with at least one fluid source (not depicted) for supplying at least one fluid (not depicted) and at least one fluid destination (not depicted) for receiving at least one fluid (not depicted). In certain embodiments, the fluid valve system 10 may comprise a housing 12 and a flow control assembly 14 disposed therein. As shown, the housing 12 may include one or more fluid inlets 16 and one or more fluid outlets 18. Each of the fluid inlets 16 may be in fluid communication with the at least one fluid source and each of the fluid outlets 18 may be in fluid communication with the at least one fluid destination. It is understood that the housing 12 may include more or less inlets 16, and outlet 18 than shown, if desired. It is further understood that each of the fluid inlets 16 may be in fluid communication with the same fluid source or separate and distinct fluid sources and each of the fluid outlets 18 may be in fluid communication with the same fluid destination or separate and distinct fluid destinations. In an exemplary embodiment, the housing 12 may include a first inlet 16a for receiving a first fluid from a first fluid source, a second inlet 16b for receiving a second fluid from a second fluid source, a first outlet 18a for distributing one of the first and second fluids to a first fluid destination, and a second outlet 18b for distributing one of the first and second fluids to a second fluid destination.

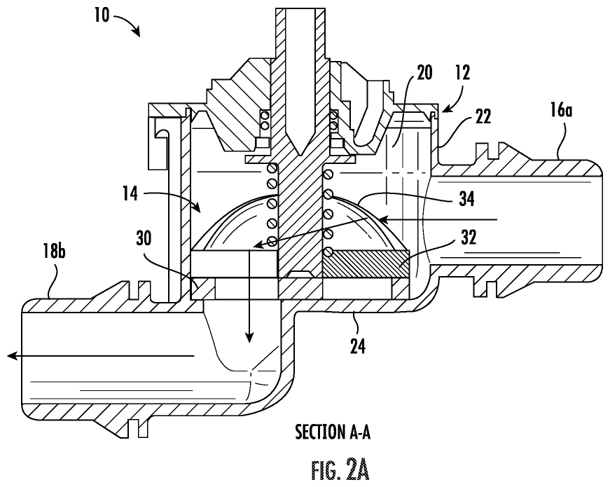

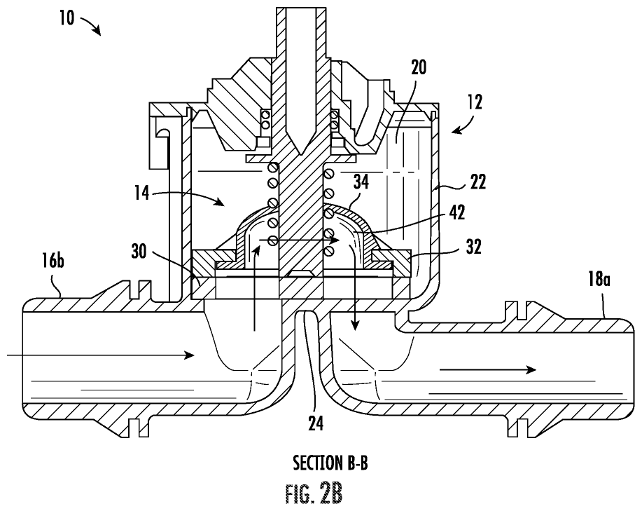

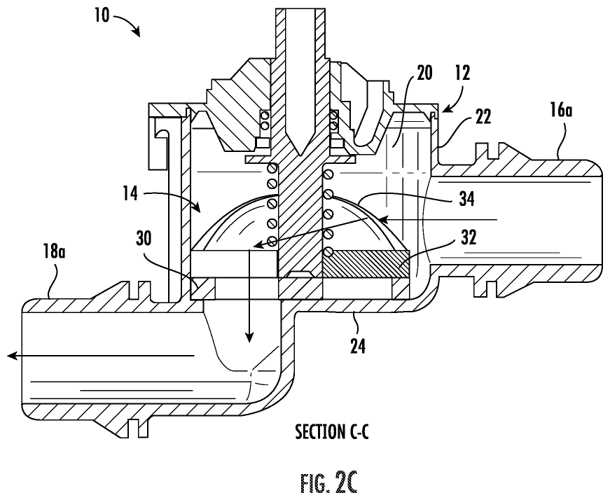

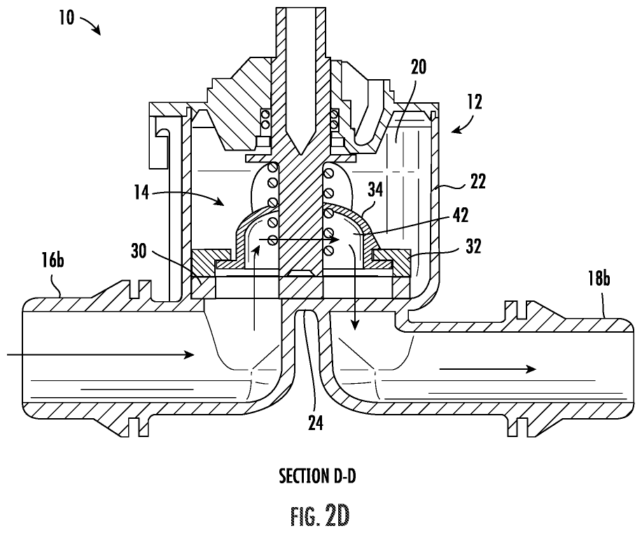

As best seen in FIG. 2, the housing 12 may include a chamber 20 defined by an outer wall 22 and an end wall 24. It should be appreciated that the chamber 20 may have any size and shape as desired to provide a desired flow of the one or more fluids therethrough. The chamber 20 may be in fluid communication with each of the inlets 16 and the outlets 18. In certain embodiments, the first inlet 16a is in fluid communication with the chamber 20 through an aperture formed in the outer wall 22 and the second inlet 16b and the outlets 18a, 18b are in fluid communication with the chamber 20 through apertures formed in the end wall 24. As such, the flow of the first fluid into the chamber 20 may be substantially perpendicular to the flow of the second fluid into the chamber 20 and the flow of the first and second fluids from the chamber 20. Additionally, each of the second inlet 16b and the outlets 18a, 18b may include a ninety-degree bend formed therein as more clearly depicted in FIG. 2.

As illustrated, the flow control assembly 14 may be disposed in the chamber 20 below the first inlet 16a yet above the second inlet 16a and the outlets 18a, 18b. The flow control assembly 14 may be configured to selectively control a flow of the fluids through the housing 12 of the fluid valve system 10. In some embodiments, the flow control assembly 14 comprises a stationary member 30 and a rotatable member 32 provided with a flow member 34. As shown in FIG. 3, the stationary member 30 may be generally circular-shaped having a plurality of openings 36 formed therein. In a non-limiting example, the stationary member 30 includes three of the openings 36, each having substantially the same shape and size. The openings 36 may be arranged in a radial array configuration and separated from one another by a web portion 38. It is understood, however, that the stationary member 30 may have any number, size, shape, and configuration of openings 36 as desired.

Referring back to FIG. 2, the stationary member 30 may be disposed in the chamber 20 of the housing 12. Preferably, the stationary member 30 may be positioned adjacent the end wall 24 of the housing 12 such that each of the openings 36 may be substantially aligned with a corresponding one of the inlets 16 and the outlets 18. In some embodiments, each of the openings 36 may be substantially aligned with a respective one of the second inlet 16b, the first outlet 18a, and the second outlet 18b to receive the flow of the fluids therethrough. At least one sealing element (not depicted) such as one or more O-rings, gaskets, elastomeric seals, and the like, for example, may be employed to form a substantially fluid-tight seal between the stationary member 30 and an inner surface of the housing 12 to militate against an undesired leakage and/or mixing of the fluids around a circumference of the stationary member 30 and/or between the openings 36.

As shown, the rotatable member 32 provided with the flow member 34 may also be disposed in the chamber 20 of the housing 12. Preferably, the rotatable member 32 may be positioned adjacent the stationary member 30. In certain embodiments, each of the stationary member 30 and the rotatable member 32 may be produced from a ceramic material such that abutment of the members 30, 32 may form a substantially fluid-tight seal therebetween. It is understood, however, that each of the members 30, 32 may be produced from other suitable materials as desired. It is further understood that various sealing methods (e.g. O-rings, gaskets, and the like) may be employed between the members 30, 32 and/or between the rotatable member 32 and the inner surface of the housing 12 to militate against an undesired leakage and/or mixing of the fluids.

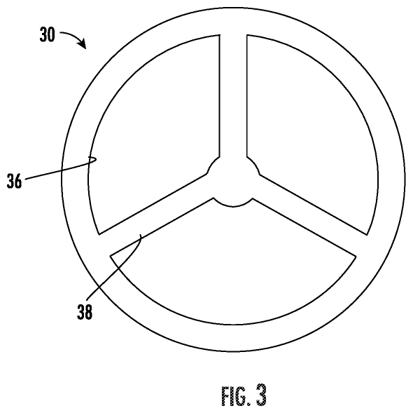

Turning now to FIG. 4, the rotatable member 32 in accordance with an embodiment of the present disclosure is illustrated. The rotatable member 32 may be generally semi-circular-shaped. In a preferred embodiment, the rotatable member 32 is shaped and sized to simultaneously cover two of the openings 36 of the stationary member 30 and leave the remaining one of the openings 36 uncovered. Accordingly, the rotatable member 32 may be configured to permit the flow of the first fluid from the first inlet 16a to a selected one of the outlets 18a, 18b. In some embodiments, the rotatable member 32 may further include at least one opening 40 formed therein. In a non-limiting example, the rotatable member 32 includes a single opening 40 having a generally arcuate shape. It is understood, however, that the rotatable member 32 may have any number, size, shape, and configuration of openings 40 as desired. Preferably, the at least one opening 40 is shaped and sized to permit the flow of the second fluid from the second inlet 16b into the flow member 34 and out of the flow member 34 to one of the outlets 18a, 18b.

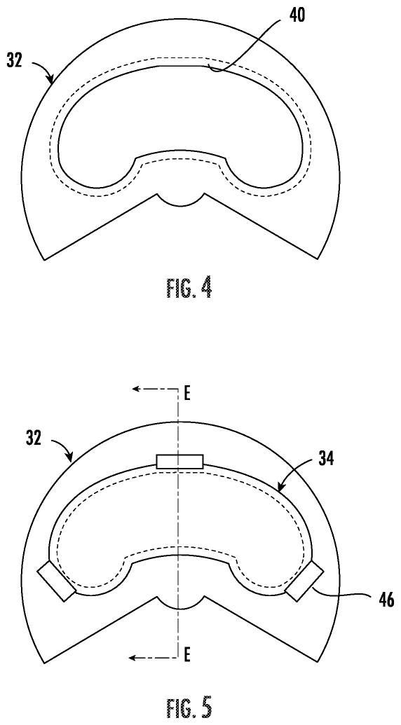

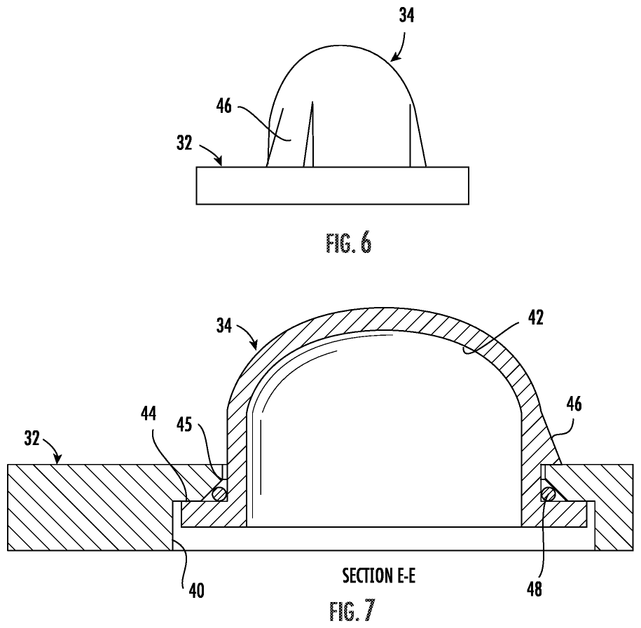

FIGS. 5-7 show an embodiment of the rotatable member 32 having the flow member 34 coupled thereto. As illustrated, the flow member 34 may be generally arcuate shaped having a semi-circular cross-section. A passageway 42 may be formed in the flow member 34 to fluidly connect the two openings 36 of the stationary member 30 covered by the rotatable member 32. Accordingly, the flow member 34 may be configured to permit the flow of the second fluid from the second inlet 16b through the passageway 42 to a selected one of the outlets 18a, 18b. In some embodiments, the flow member 34 may be releaseably coupled to the rotatable member 32. It is understood, however, that the flow member 34 may be fixedly coupled to the rotatable member 32, if desired.

As more clearly shown in FIG. 6, an upper portion of the flow member 34 may be inserted through the at least one opening 40 of the rotatable member 32. An outwardly extending peripheral flange 44 of the flow member 34 may engage an inwardly extending portion 45 of the rotatable member 32. The flow member 34 may further include one or more retaining elements 46 such as outwardly extending protuberances (e.g. locking tabs), for example. As illustrated, the flow member 34 may be releaseably coupled to the rotatable member 32 by clamping the inwardly extending portion 45 of the rotatable member 32 between the outwardly extending peripheral flange 44 and the retaining elements 46 of the flow member 34. Various types of retaining elements 46 and other retaining methods may be employed to secure the flow member 34 to the rotatable member 32. At least one sealing element 48, such as one or more O-rings, gaskets, elastomeric seals, and the like, for example, may be disposed between the flow member 34 and the rotatable member 32 to form a substantially fluid-tight seal therebetween to militate against an undesired leakage and/or mixing of the fluids.

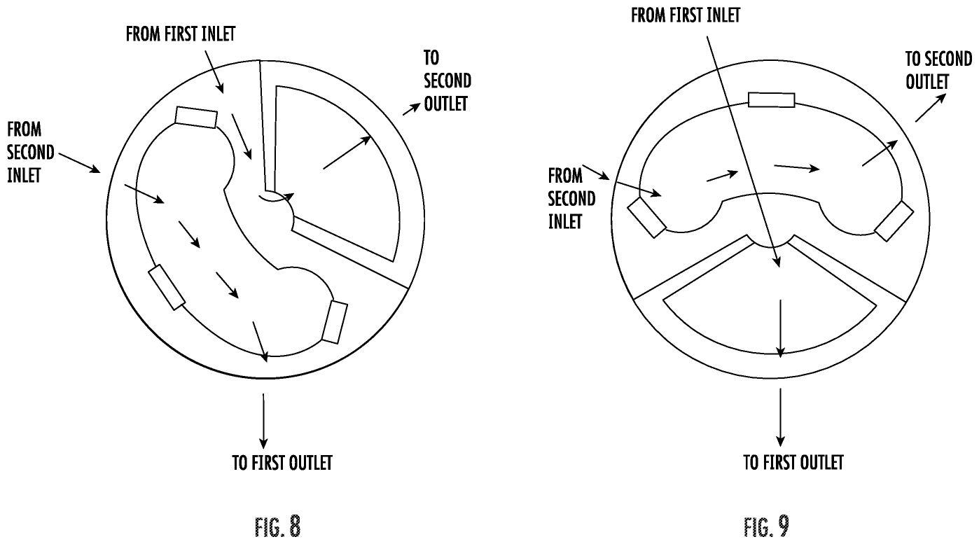

FIGS. 8 and 9 illustrate operating modes of the flow control assembly 14. In a first operating mode shown in FIG. 8, the rotatable member 32 provided with the flow member 34 may be in a first position relative to the stationary member 30. When in the first position, the rotatable member 32 covers the openings 36 in fluid communication with the second inlet 16b and the first outlet 18a leaving the opening 36 in fluid communication with the second outlet 18b uncovered. Accordingly, the first fluid supplied by the first fluid source may be permitted to flow through a first flow path to the second fluid destination, wherein the first flow path may be defined by the first inlet 16a in fluid communication with the second outlet 18b through the chamber 20 of the housing 14 and the uncovered opening 36 of the stationary member 30 in fluid communication with the second outlet 18b. Simultaneously or alternatively, the second fluid supplied by the second fluid source may be permitted to flow through a second flow path to the first fluid destination, wherein the second flow path may be defined by the second inlet 16b in fluid communication with the first outlet 18a, through the opening 36 in fluid communication with the second inlet 16b, the passageway 42 formed in the flow member 34, and the opening 36 in fluid communication with the first outlet 18a.

In a second operating mode shown in FIG. 9, the rotatable member 32 provided with the flow member 34 may be in a second position relative to the stationary member 30. In some embodiments, the rotatable member 32 may rotate about 120° from the first position to the second position. When in the second position, the rotatable member 32 covers the openings 36 in fluid communication with the second inlet 16b and the second outlet 18b leaving the opening 36 in fluid communication with the first outlet 18a uncovered. Accordingly, the first fluid supplied by the first fluid source may be permitted to flow through a third flow path to the first fluid destination, wherein the third flow path may be defined by the first inlet 16a in fluid communication with the first outlet 18a through the chamber 20 of the housing 14 and the uncovered opening 36 of the stationary member 30 in fluid communication with the first outlet 18a. Simultaneously or alternatively, the second fluid supplied by the second fluid source may be permitted to flow through a fourth flow path to the second fluid destination, wherein the fourth flow path may be defined by the second inlet 16b in fluid communication with the second outlet 18b, through the opening 36 in fluid communication with the second inlet 16b, the passageway 42 formed in the flow member 34, and the opening 36 in fluid communication with the second outlet 18b.

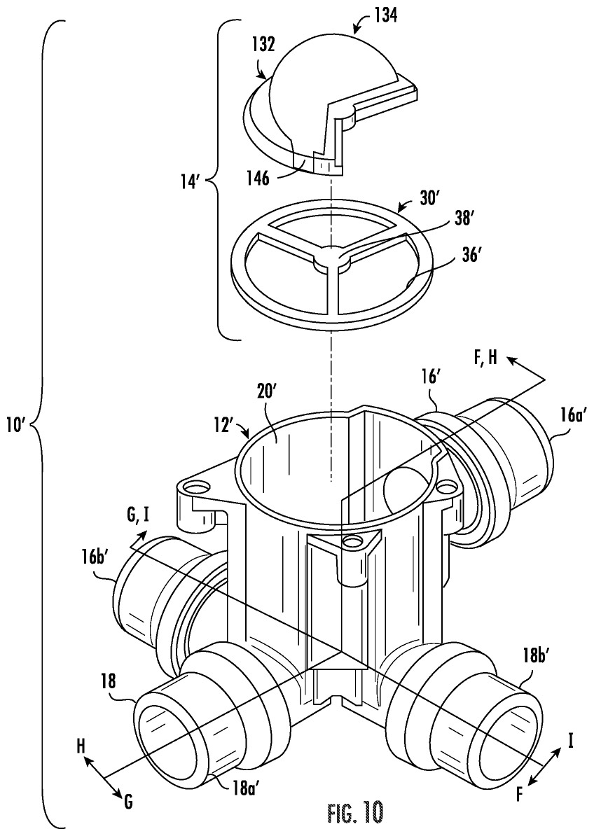

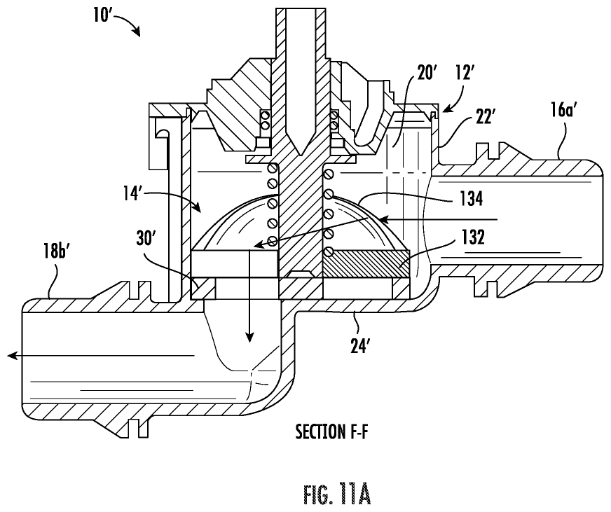

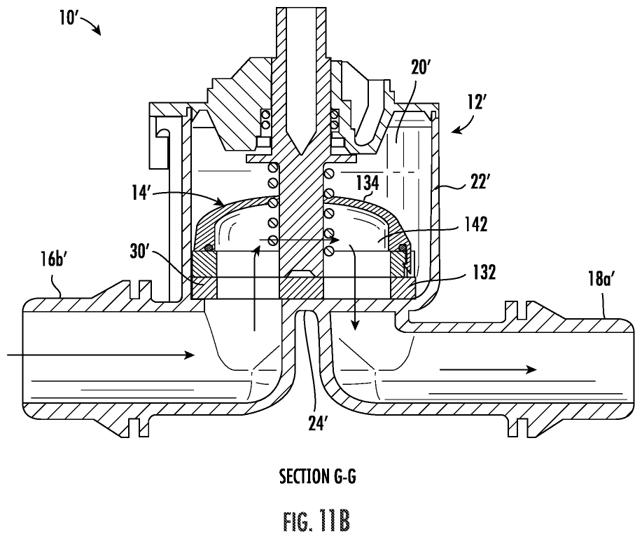

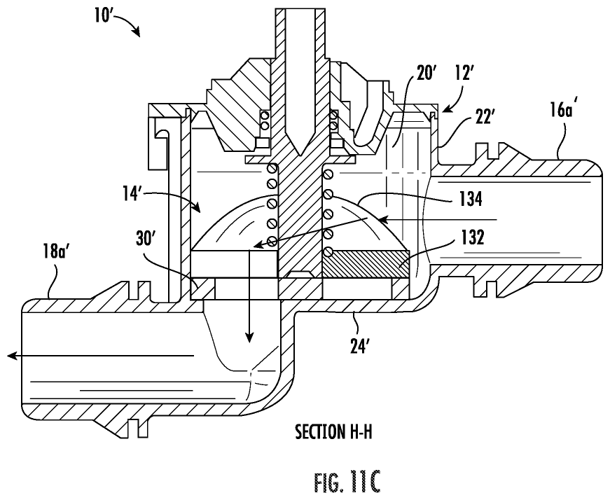

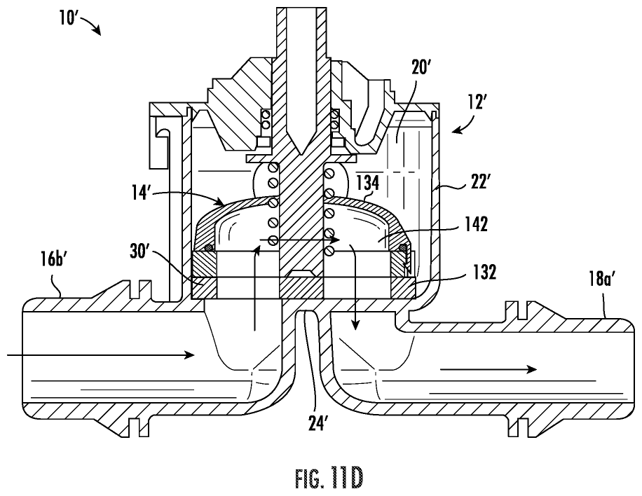

FIG. 10 illustrates a fluid valve assembly 10′ including a flow control assembly 14′ in accordance with another embodiment of the present disclosure. More particularly, the flow control assembly 14′ comprises a stationary member 30′ and another embodiment of a rotatable member 132 provided with a flow member 134 as shown in FIGS. 11-15. Similar structure to that described above for FIGS. 1-9 repeated herein with respect to FIGS. 10-15 includes the same reference numeral and a prime (′) symbol.

The rotatable member 132 may be generally semi-circular-shaped. In a preferred embodiment, the rotatable member 132 is shaped and sized to simultaneously cover two of the openings 36′ of the stationary member 30′ and leave the remaining one of the openings 36′ uncovered. Accordingly, the rotatable member 132 may be configured to permit the flow of the first fluid from the first inlet 16a′ to a selected one of the outlets 18a′, 18b′. In some embodiments, the rotatable member 132 may further include at least one opening 140 formed therein. In a non-limiting example, the rotatable member 132 includes a single opening 140 having a generally arcuate shape. It is understood, however, that the rotatable member 132 may have any number, size, shape, and configuration of openings 140 as desired. Preferably, the at least one opening 140 is shaped and sized to permit the flow of the second fluid from the second inlet 16b′ into the flow member 134 and out of the flow member 134 to one of the outlets 18a′, 18b′.

As illustrated, the flow member 134 may be generally arcuate shaped having a semi-circular cross-section. A passageway 142 may be formed in the flow member 134 to fluidly connect the two openings 36′ of the stationary member 30′ covered by the rotatable member 132. Accordingly, the flow member 134 may be configured to permit the flow of the second fluid from the second inlet 16b′ through the passageway 142 to a selected one of the outlets 18a′, 18b′. In some embodiments, the flow member 134 may be releaseably coupled to the rotatable member 132. It is understood, however, that the flow member 134 may be fixedly coupled to the rotatable member 132, if desired.

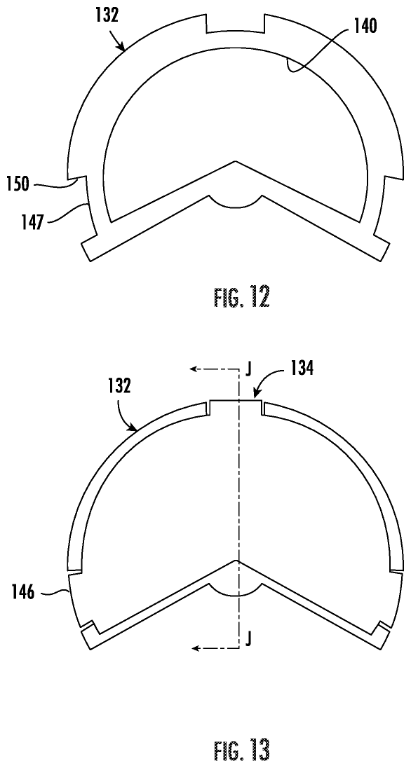

As more clearly shown in FIG. 12, the flow member 134 may be disposed on an upper surface of the rotatable member 132 with the passageway 142 of the flow member 134 substantially aligned with the at least one opening 140 of the rotatable member 132. The flow member 134 may further include one or more retaining elements 146 such as downwardly extending protuberances (e.g. locking tabs), for example. As illustrated, the flow member 134 may be releaseably coupled to the rotatable member 132 by engagement of the retaining elements 146 with a peripheral portion 147 of the rotatable member 132. In some embodiments, the rotatable member 132 may further include one or more recesses 150 formed in an outer periphery thereof to receive a corresponding one of the retaining elements 146 therein. Various types of retaining elements 146 and other retaining methods may be employed to secure the flow member 134 to the rotatable member 132. At least one sealing element 148, such as one or more O-rings, gaskets, elastomeric seals, and the like, for example, may be disposed between the flow member 134 and the rotatable member 132 to form a substantially fluid-tight seal therebetween to militate against an undesired leakage and/or mixing of the fluids.

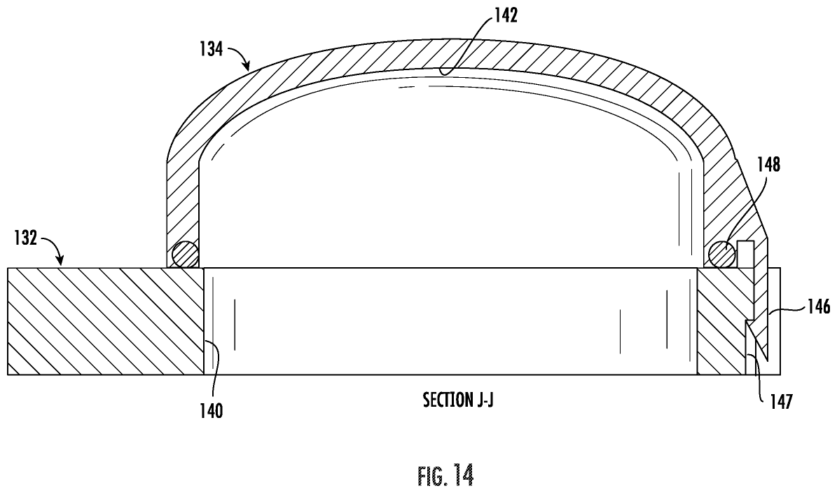

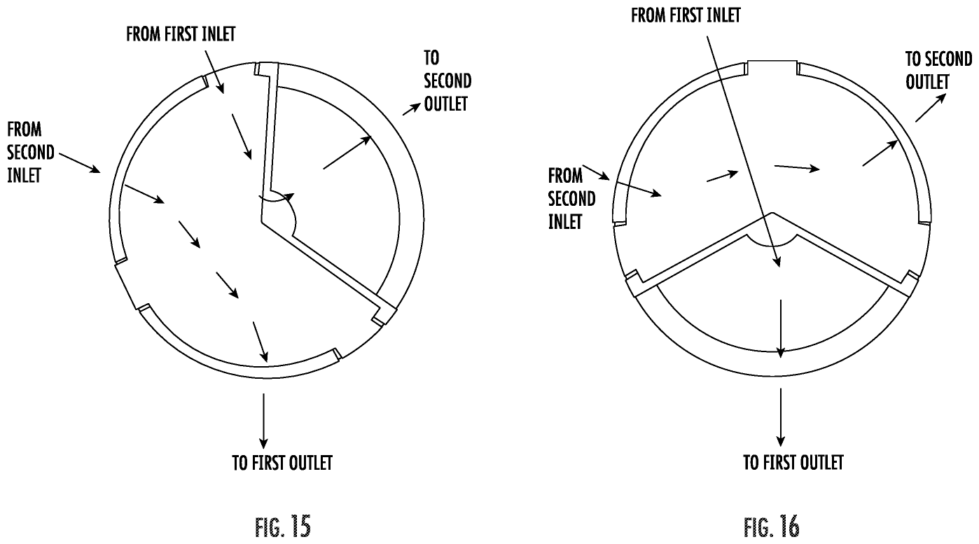

FIGS. 13 and 14 illustrate operating modes of the flow control assembly 14′ including the stationary member 30′ and the rotatable member 132 provided with the flow member 134. In a first operating mode shown in FIG. 13, the rotatable member 132 provided with the flow member 134 may be in a first position relative to the stationary member 30′. When in the first position, the rotatable member 132 covers the openings 36′ in fluid communication with the second inlet 16b′ and the first outlet 18a′ leaving the opening 36′ in fluid communication with the second outlet 18b′ uncovered. Accordingly, the first fluid supplied by the first fluid source may be permitted to flow through a first flow path to the second fluid destination, wherein the first flow path may be defined by the first inlet 16a′ in fluid communication with the second outlet 18b′ through the chamber 20′ of the housing 14′ and the uncovered opening 36′ of the stationary member 30′ in fluid communication with the second outlet 18b′. Simultaneously or alternatively, the second fluid supplied by the second fluid source may be permitted to flow through a second flow path to the first fluid destination, wherein the second flow path may be defined by the second inlet 16b′ in fluid communication with the first outlet 18a′, through the opening 36′ in fluid communication with the second inlet 16b′, the passageway 142 formed in the flow member 134, and the opening 36′ in fluid communication with the first outlet 18a′.

In a second operating mode shown in FIG. 14, the rotatable member 132 provided with the flow member 134 may be in a second position relative to the stationary member 30′. In some embodiments, the rotatable member 132 may rotate about 120° from the first position to the second position. When in the second position, the rotatable member 132 covers the openings 36′ in fluid communication with the second inlet 16b′ and the second outlet 18b′ leaving the opening 36′ in fluid communication with the first outlet 18a′ uncovered. Accordingly, the first fluid supplied by the first fluid source may be permitted to flow through a third flow path to the first fluid destination, wherein the third flow path may be defined by the first inlet 16a′ in fluid communication with the first outlet 18a′ through the chamber 20′ of the housing 14′ and the uncovered opening 36′ of the stationary member 30′ in fluid communication with the first outlet 18a′. Simultaneously or alternatively, the second fluid supplied by the second fluid source may be permitted to flow through a fourth flow path to the second fluid destination, wherein the fourth flow path may be defined by the second inlet 16b′ in fluid communication with the second outlet 18b′, through the opening 36′ in fluid communication with the second inlet 16b′, the passageway 142 formed in the flow member 134, and the opening 36′ in fluid communication with the second outlet 18b′.

Now referring to FIGS. 2 and 10, the fluid valve systems 10, 10′ may further include an actuator 200, 200′, respectively. The actuators 200, 200′ may be drivingly coupled to a respective one of the flow control assemblies 14, 14′ to cause a rotational movement of the rotatable members 32, 132. The actuators 200, 200′ may cause a rotational movement of the rotatable members 32, 132 in a first rotational direction (e.g. clockwise) and an opposite second rotational direction (e.g. counter-clockwise). More preferably, the actuators 200, 200′ may cause the rotational movement of the rotatable members 32, 132 in the first rotational direction from the first position to the second position, and in the second rotational direction from the second position to the first position. The actuators 200, 200′ may be powered by any electric motor with an ability to generate rotary motion. For example, the actuators 200, 200′ may be driven by a stepper motor or a brushless DC (BLDC) motor. It is understood that other methods of actuation and causing the rotational movement of the rotatable members 32, 132 of the respective flow control assemblies 14, 14′ may be used.

It is understood that operations of the fluid valve systems 10, 10′ are substantially the same, and therefore, for simplicity purposes, only the operation of the fluid valve system 10 is described hereinafter.

In operation when fluid flow through the first flow path and/or the second flow path is desired, the flow control assembly 14 is positioned in the first position, as shown in FIG. 8, via the actuator 200. When the flow control assembly 14 is in the first position, the first fluid is permitted to flow through the first flow path and the second fluid is permitted to flow through the second flow path. Specifically, the first fluid flows from the first fluid source through the first inlet 16a and into the chamber 20 of the housing 12. From the chamber 20, the first fluid flows downwards through the uncovered one of the openings 36, into and through the second outlet 18b, and to the second fluid destination. Simultaneously or alternatively, the second fluid flows from the second fluid source through the second inlet 16b, upwards through one of the openings 36 covered by the rotatable member 32, into and through the passageway 42 of the flow member 34, downwards through another one of the openings 36 covered by the rotatable member 32, into and through the first outlet 18a, and to the first fluid destination.

In operation when fluid flow through the third flow path and/or the fourth flow path is desired, the flow control assembly 14 is positioned in the second position, as shown in FIG. 9, via the actuator 200. When the flow control assembly 14 is in the second position, the first fluid is permitted to flow through the third flow path and the second fluid is permitted to flow through the fourth flow path. Specifically, the first fluid flows from the first fluid source through the first inlet 16a and into the chamber 20 of the housing 12. From the chamber 20, the first fluid flows downwards through the uncovered one of the openings 36, into and through the first outlet 18a, and to the first fluid destination. Simultaneously or alternatively, the second fluid flows from the second fluid source through the second inlet 16b, upwards through one of the openings 36 covered by the rotatable member 32, into and through the passageway 42 of the flow member 34, downwards through another one of the openings 36 covered by the rotatable member 32, into and through the second outlet 18b, and to the second fluid destination.

The fluid valve systems 10, 10′ may be employed in various applications such as proportional flow application, thermal energy exchange applications, and the like, for example. It should be appreciated that the fluid valve systems 10, 10′ may be employed in any suitable application as desired.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A flow control assembly, comprising:
a first member having a plurality of openings formed therein; and
a second member provided with a flow member, wherein the second member is configured to selectively control a flow of a plurality of fluids through the openings formed in the first member.

2. The flow control assembly of claim 1, wherein the first member is stationary.

3. The flow control assembly of claim 1, wherein the second member is rotatable relative to the first member.

4. The flow control assembly of claim 1, wherein the flow member fluidly connects one of the openings formed in the first control member to another one of the openings formed therein.

5. The flow control assembly of claim 1, wherein the flow member fluidly connects a fluid inlet with a fluid outlet.

6. The flow control assembly of claim 1, wherein the first member has a generally circular shape.

7. The flow control assembly of claim 1, wherein the second member has a generally semi-circular shape.

8. The flow control assembly of claim 1, wherein the flow member includes a passageway formed therein.

9. The flow control assembly of claim 1, wherein the flow member is releasably coupled to the second member.

10. The flow control assembly of claim 1, wherein the flow member includes a plurality of retaining elements configured to cooperate with the second member to secure the flow member thereto.

11. The flow control assembly of claim 1, further comprising a sealing element disposed between the second member and the flow member to form a substantially fluid-tight seal therebetween.

12. A fluid valve system, comprising:
a housing defining a plurality of flow paths; and
a flow control assembly disposed in the housing, wherein the flow control assembly is configured to selectively control a flow of at least one fluid through the flow paths of the housing.

13. The fluid valve system of claim 12, wherein the housing includes a plurality of fluid inlets and a plurality of fluid outlets.

14. The fluid valve system of claim 12, wherein the flow control assembly is positioned in the housing between a first inlet and a second inlet.

15. The fluid valve system of claim 12, wherein the flow control assembly includes a flow member having a passageway formed therein, and wherein the passageway is configured to permit the flow of the at least one fluid through at least one of the flow paths.

16. The fluid valve system of claim 12, wherein the housing defines a first flow path, a second flow path, a third flow path, and a fourth flow path.

17. The fluid valve system of claim 16, wherein the housing includes a first inlet, a second inlet, a first outlet, and a second outlet, and wherein the first flow path is configured to permit a flow of a first fluid from the first inlet to the second outlet, the second flow path is configured to permit a flow of a second fluid from the second inlet to the first outlet, the third flow path is configured to permit a flow of the first fluid from the first inlet to the first outlet, and the fourth flow path is configured to permit a flow of the second fluid from the second inlet to the first outlet.

18. The fluid valve system of claim 17, wherein the flow control assembly includes a stationary member and a rotatable member configured to rotate relative to the stationary member.

19. The fluid valve system of claim 18, wherein the rotatable member in a first position is configured to permit the flow of the first fluid through the first flow path and the flow of the second fluid through the second flow path, and wherein the rotatable member in a second position is configured to permit the flow of the first fluid through the third flow path and the flow of the second fluid through the fourth flow path.

20. A method of controlling fluid flow, comprising the steps of:
providing a housing defining a plurality of fluid flow paths and a flow control assembly disposed in the housing; and
actuating the flow control assembly to selectively control a flow of at least one fluid through the fluid flow paths of the housing.
